(19) United States
(12) Patent Application Publication
(10) Pub. No.: US 2021/0147026 A1
(43) Pub. Date: May 20, 2021

(54) ASSEMBLY, METHOD, AND SYSTEM FOR IMPROVING THE ACCURACY OF WIRELESS BRAKE LIGHTS

(71) Applicant: Byron Terrell Cooke, New Orleans, LA (US)

(72) Inventor: Byron Terrell Cooke, New Orleans, LA (US)

(21) Appl. No.: 16/949,482

(22) Filed: Oct. 30, 2020

Related U.S. Application Data
(60) Provisional application No. 62/937,521, filed on Nov. 19, 2019.

(51) Int. Cl. B62J 6/165; B62L 3/02; B62J 6/045; B62J 45/20; B62K 23/06; A42B 3/04

(52) U.S. Cl. CPC B62J 6/165; B62L 3/02; B62J 6/045; A42B 3/0453; B62K 23/06; A42B 3/044; B62J 45/20

(57) ABSTRACT

A brake lever switch assembly for a vehicle is provided. The brake lever switch assembly includes a brake lever physically linked to a brake lever switch; and the brake lever switch physically connected to a transmitter configured to propagate a wireless signal based on a state of the brake lever determined between the brake lever switch and the wireless signal.

### CROSS-REFERENCE TO RELATED APPLICATION

This application claims the benefit of priority of U.S. provisional application No. 62/937,521, filed 19 Nov. 2019, the contents of which are herein incorporated by reference.

### BACKGROUND OF THE INVENTION

The present invention relates to braking systems and more particularly a brake lever switch assembly for improving the accuracy of wireless brake light systems.

Wireless brake light systems for motorcycles or bicycles have a brake indicator light mounted on riding helmets so that when the rider applies the brakes a signal is relayed from the bike to the rider's helmet to engage the brake indicator light on the helmet.

Current brake light systems use switches and sensors to determine the state of braking. This “braking state” is used to determine the signal wirelessly transmitted to the brake indicator light mounted on the riding helmet. Using sensors to determine the braking state physically disconnects the brake lever from the braking signal generation process. Currently, sensor-dependent switches are prone to glitches, malfunctions, and other errors because of the physical disconnection between the brake lever and the braking state detection mechanism. And as a result, errors in activation of the brake indicator light can have dangerous consequences.

As can be seen, there is a need for a brake lever switch enabling a wireless brake light system for a riding helmet wherein an electrical switch is physically connected to the brake lever (in a brake lever switch housing) to increase the accuracy of the braking signal generation process. The present invention embodies an assembly, a process, and a system that streamlines and simplifies the solution to the above-mentioned process.

The present invention intrinsically couples and inextricably links the existing brake lever functionality with the braking state determination, thereby increasing the accuracy of the braking signal generation. The brake lever switch of the present invention in the brake lever housing can be built into newly manufactured or can replace a standard brake lever.

An additional advantage for the present invention is that removal of sensors and other disconnected braking state determining elements allows the rider to have wireless brake lights without additional features added to the handlebar, which can lower performance of the vehicle's aerodynamics, and can become an obstacle that requires the rider to be mindful of along with many other things the rider must focus on. Additional features could also be aesthetically unpleasing.

The brake lever switch for the wireless brake light system provides a way to integrate the vehicle's braking system with the wireless brake light system through inexplicably linking the physical application of the braking system with the wireless brake light system.

In short, when the brakes (for instance a bicycle using a cable system) are applied, the brake lever switch is engaged, sending a signal to the wireless brake systems transmitter module that determines the state of the brake switch. The transmitter module sends the signal to the helmet module which activates the brake indicator. The transmitter module may be attached to or incorporated into any part of the vehicle to wirelessly send signals to the helmet module.

### SUMMARY OF THE INVENTION

In one aspect of the present invention, a brake lever switch assembly for a vehicle, the brake lever switch assembly includes the following: a brake lever physically linked to a brake lever switch; and the brake lever switch physically connected to a transmitter configured to propagate a wireless signal based on a state of the brake lever determined between the brake lever switch and the wireless signal.

In another aspect of the present invention, the above brake lever switch assembly includes the brake lever being pivotable associated to a lever pivot point; and the brake lever switch operatively associated to the lever pivot point, wherein the brake lever switch is a push button, wherein the brake lever switch is housed in a brake lever switch housing connected to a control assembly of the vehicle, wherein the vehicle is a bicycle and the control assembly is a handlebar of the bicycle; and including a brake light having a receiver configured to activate the brake light upon receiving the wireless signal, wherein the brake light is connected to a helmet.

In yet another aspect of the present invention, the accuracy of a wireless brake light system of a vehicle can be improved by attaching a brake lever switch assembly to a control assembly of the vehicle, the brake lever switch assembly including a brake lever physically linked to a brake lever switch; and the brake lever switch physically connected to a transmitter configured to propagate a wireless signal based on a state of the brake lever determined between the brake lever switch and the wireless signal, wherein the wireless signal activates the wireless brake light system, and wherein retrofitting of an existing vehicle would include initially removing the existing brake lever housing of the vehicle prior to installation of the brake lever switch assembly, preferably in a housing.

These and other features, aspects and advantages of the present invention will become better understood with reference to the following drawings, description and claims.

### BRIEF DESCRIPTION OF THE DRAWINGS

FIG. 1 is an elevation view of an exemplary embodiment of the present invention;

FIG. 2 is a detailed side elevation view of an exemplary embodiment of the present invention, taken along line 2-2 in FIG. 1, with the switch assembly housing broken away to show the internal components; and

FIG. 3 is a schematic view of an exemplary embodiment of the present invention shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention may include barrel adjuster 3, an electrical wire 14c, a push button switch 14m, a brake lever 12c, a brake cable housing 12d, handlebar 12a, a handlebar grip 12b, a brake lever switch housing 14e, a lever pivot point 14g, a locking nut 14b, a waterproof seal 14d, a waterproof switch protector 14l, a protector holder cap 14k, a switch housing 14h, a switch housing screw 14i, a switch cavity 14j, a brake switch port 14a, and a brake cable port 14f.

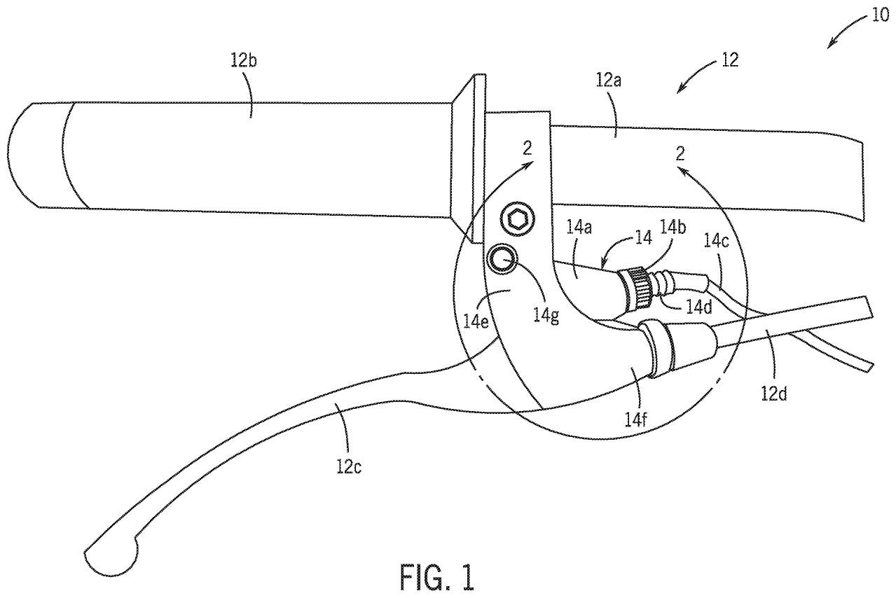

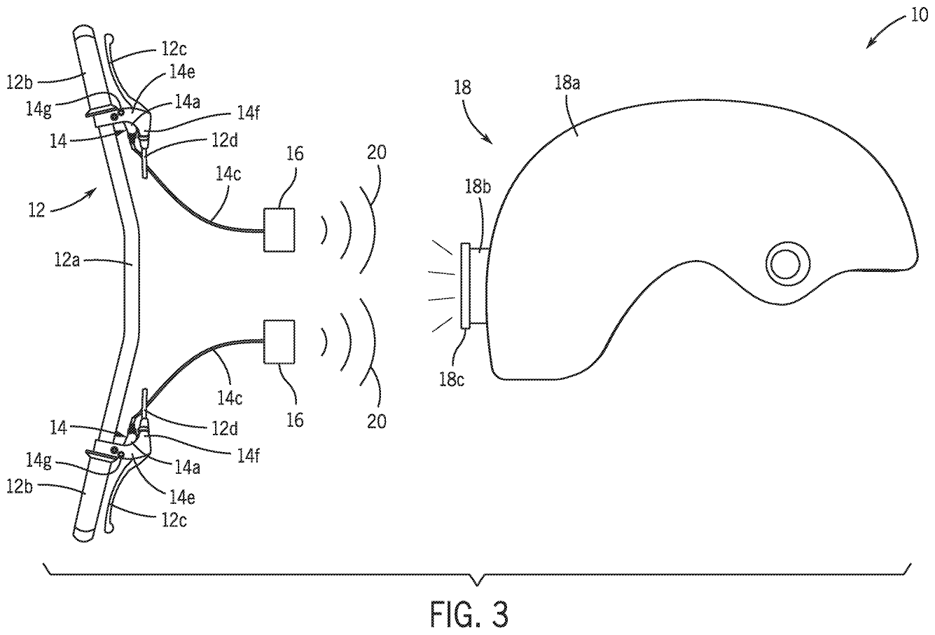

Referring now to FIGS. 1 through 3, the present invention includes a brake lever switch assembly for use with a wireless brake light system. It should be understood that, although the appended figures are directed to handlebar assemblies for bicycles, the present invention is adaptable for other types of vehicles (motorcycles, jet skis, all-terrain vehicles, etc.) and their different vehicular control assemblies (e.g., a steering wheel as opposed to handlebars). Likewise, the downstream braking light/indicator may be connected to a helmet (as shown in the FIG. 3) or other portions of the rider or the vehicle itself.

The brake lever switch assembly may include a brake lever switch 14m housed in a brake lever switch housing 14e. The brake lever switch housing 14e may be attached on a vehicular control assembly 12 (in embodiments, the hand grip 12b of the handlebars 12a) where the brake lever 12c is disposed. In some embodiments, the brake lever switch assembly of the present invention would take the place of existing brake levers or it would be provided during the manufacture of the vehicle. In any event, the bike brake cable (typically by way of its brake cable housing 12d) is routed to the brake lever switch housing 14e through a cable port 14f but otherwise functions as normal.

The brake lever switch 14m may be adapted to be activated when the brake lever 12c is engaged to apply the brakes. Specifically, in certain embodiments, the brake lever switch 14m may be physically connected to the lever pivot point 14g in such a way that when the brake lever 12c pivots at the lever pivot point 14g, the brake lever switch 14m is operatively engaged. In certain embodiments, the brake lever switch 14m may be a push button that is pressed, depressed or otherwise urged to be operatively engaged. Operative engagement causes a signal through an electrical wire 14c to the wireless brake light systems transmitter module 16. The transmitter module 16 may have a digital logic processor sufficient to at least distinguish said signal from no signal (true from false, 1 from 0, on-state from off-state, etc.). In certain embodiments, the digital logic processor may be embodied in the brake lever switch 14m, and so the transmitter module 16 is not processing the signal for the determination of on-state/off-state. In either event, the transmitter module 16 is adapted to transmit a braking state signal 20 of the on-state and/or the off-state to a receiver 18b for the brake light 18c. The brake light 18c may be connected to an object 18a associated with the vehicle or the rider of the vehicle (such as a helmet 18a) defining an overall assembly brake light assembly 18.

The electrical wire 14c may have a connector on the end that clips into the transmitter module 16. The electric wire 14c can be anything that conveys electrical data and that can be split and have multiple connectors for multiple purposes.

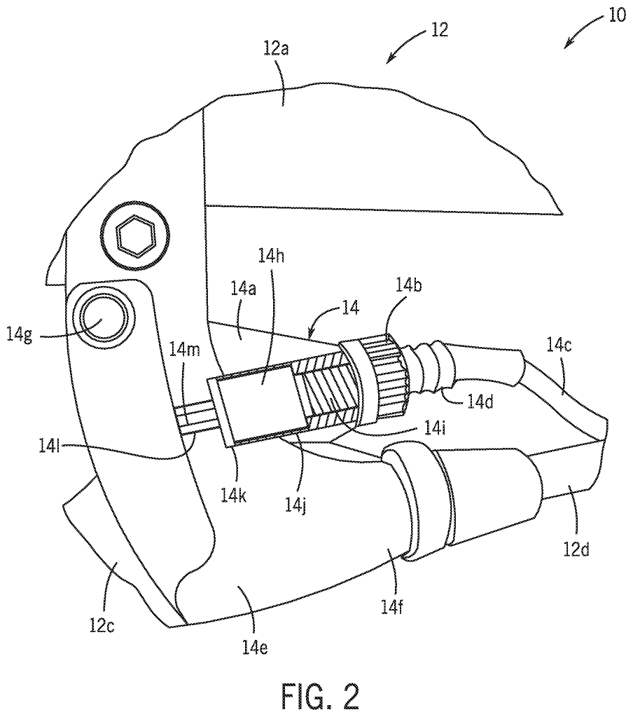

The brake lever switch 14m may be housed in a switch cavity 14j within the brake lever switch housing 14e. The switch cavity 14j may be adapted to hold the switch in place at the correct angle to operatively engage the brake lever 12c The brake lever switch 14m may be secured to the switch port 14a and held in place with a locking fastener (such as a nut) 14b. The locking fastener 14b may connect to the switch housing fastener (such as a screw)14i that may be an extension to the switch housing 14h. The switch housing can be made in many shapes mainly square, rectangle or round to fit in the switch cavity 14j that is also shaped to fit the switch. FIG. 2 shows the waterproofing features of the brake lever switch. On the switch end, it shows a waterproof switch protector 14l that covers the push button switch 14m and the top of the switch housing 14h. The waterproof switch protector 14l may be held in place with a protector holder cap 14k that can either screw on or snap on to the brake switch housing 14h. The switch housing 14h may be made of a material such as plastic that protects the switch. On the back end of the switch, the switch housing 14h may have a waterproof seal 14d that extends into the switch housing fastener 14i to protect the wire connections from rain, dust or other elements.

The brake lever switch assembly disclosed above allows an existing vehicular brake cable system to continue to work as intended. The brake cable is attached to the brake lever as normal. The brake lever switch wire is then connected to the wireless brake light systems transmitter module 16 that is mounted on the vehicle or incorporated within the vehicle's components.

In other words, when the brake lever is engaged, the inextricably linked brake lever switch is engaged allowing the circuit to be opened or closed. This results in a wireless signal to the microprocessor as to the state in which the brake is in. The motorcycle or bicycles microprocessor located in the physically connected portion of the brake lever/brake lever switch/transmitter module determines the signal state and then sends a wireless signal to the rider's helmet microprocessor module to either turn the lights on or off.

The brake lever housing may incorporate a cavity that will allow the brake lever (push button) switch and switch housing to be inserted. The brake lever housing may have an additional port to accept and allow the brake lever switch to be inserted and securely attached. The brake housing may be made of a non-corrosive material or metal such as aluminum or stainless steel that is strong and reliable to ensure the brake is operational. The brake lever switch housing may be made of materials that resists water and will not allow dust or other elements to interfere with the switching functionality. The waterproofing and weatherproofing may not be necessary when used in certain environments. The brake cable port and the brake switch port can be switched, putting the brake switch on the bottom of the brake lever housing rather than the top position or vice versa.

The brake lever switch disclosed above enables existing bicycles to be retrofitted with easy installation of the present invention that incorporates the brake lever switch for use with a wireless brake light and/or display system. The brake lever switches could be mounted on the handlebar where a standard brake cable lever would be mounted. Generally, there would be two brake lever switches installed. One for the front brake and one for the rear brake. The brake lever switch electrical connection is coupled to the wireless brake light and display systems transmitter module that is mounted, installed or incorporated on or within the vehicle.

Additionally, the present invention can be used to control the motor of an electric or “e-Bike” or “e-scooter”. It can also be used to turn on or off a brake light mounted on the rear of a bike.

It should be understood, of course, that the foregoing relates to exemplary embodiments of the invention and that modifications may be made without departing from the spirit and scope of the invention as set forth in the following claims.

What is claimed is:

1. A brake lever switch assembly for a vehicle, the brake lever switch assembly comprising:
a brake lever physically linked to a brake lever switch; and
the brake lever switch physically connected to a transmitter configured to propagate a wireless signal based on a state of the brake lever determined between the brake lever switch and the wireless signal.

2. The brake lever switch assembly of claim 1, wherein the brake lever is pivotable associated to a lever pivot point; and
the brake lever switch operatively associated to the lever pivot point.

3. The brake lever switch assembly of claim 2, wherein the brake lever switch is a push button.

4. The brake lever switch assembly of claim 2, wherein the brake lever switch is housed in a brake lever switch housing connected to a control assembly of the vehicle.

5. The brake lever switch assembly of claim 4, wherein the vehicle is a bicycle and the control assembly is a handlebar of the bicycle.

6. The brake lever switch assembly of claim 5, further comprising a brake light having a receiver configured to activate the brake light upon receiving the wireless signal.

7. The brake lever switch assembly of claim 6, wherein the brake light is connected to a helmet.

8. A method for improving accuracy of a wireless brake light system of a vehicle, the method comprising:
attaching a brake lever switch assembly to a control assembly of the vehicle, the brake lever switch assembly comprising:
a brake lever physically linked to a brake lever switch; and
the brake lever switch physically connected to a transmitter configured to propagate a wireless signal based on a state of the brake lever determined between the brake lever switch and the wireless signal, wherein the wireless signal activates the wireless brake light system.

9. The method of claim 8, further comprising initially removing an existing brake lever housing of the vehicle,
whereby the vehicle is retrofitted post manufacturer.
